(19) United States
(12) Patent Application Publication
(10) Pub. No.: US 2002/0061682 A1
(43) Pub. Date: May 23, 2002

(54) Fuse, fuse mounting structure and fuse circuit

(75) Inventors: Ryuji Nakanishi, Nagoya-shi (JP); Shigeki Yamane, Nagoya-shi (JP); Takahiro Onizuka, Nagoya-shi (JP); Isao Isshiki, Nagoya-shi (JP)

Correspondence Address: OLIFF & BERRIDGE, PLC, P.O. BOX 19928, ALEXANDRIA, VA, 22320, US

(73) Assignee: AUTONETWORKS TECHNOLOGIES, LTD., Nagoya-shi (JP)

(21) Appl. No.: 09/988,345

(22) Filed: Nov. 19, 2001

(30) Foreign Application Priority Data
Nov. 22, 2000 (JP) 2000-355230
Dec. 21, 2000 (JP) 2000-388343

(51) Int. Cl. H01R 13/68

(52) U.S. Cl. 439/622

(57) ABSTRACT

A fuse main body made of a conductor in which connection terminals are provided at the opposite ends of a fusing portion is covered by an insulating covering member except part of the two connection terminals. The connection terminals are electrically connected with the fuse by being inserted into forked inserting portions of press-contact blades. The covering member is formed with slit-shaped notches which are shaped such that leading ends of the press-contact blades are insertable and adapted to partly expose the connection terminals. The height of the fuse can be shortened, which in turn contributes to a substantially smaller electrical connection box in which the fuse is to be mounted.

### BACKGROUND OF THE INVENTION

This invention relates to a fuse to be mounted in a connection casing such as an outermost casing of an electrical connection box used in, for example, a vehicle, a fuse mounting structure and a fuse circuit.

A known method for mounting a fuse in the aforementioned electrical connection box is such that connection terminals 211 of a fuse 210 are inserted into inserting portions 203 of press-contact blades 202 shown in FIG. 20 provided in a fuse mounting section 201 of an electrical connection box 200.

As shown in FIG. 21 (exploded perspective view), the press-contact blades 202 are provided inside the electrical connection box 200. On the other hand, the fuse 210 is constructed to include a fuse main body 213 having the connection terminals 211 provided at the opposite ends of a fusing portion 212 and an insulating covering portion 214 for covering the entire fusing portion 212 and part of the connection terminals 211 as shown in FIG. 22.

In recent years, automotive vehicles have been demanded to have comfortable equipments while being demanded to improve its comfort in a passenger's compartment. In order to simultaneously satisfy these contradictory demands, electrical connection boxes used in automotive vehicles need to be smaller and more lightweight under the circumstances where the comfortable equipments are on the increase.

However, under the present circumstances where the comfortable equipments are on the increase, the number of the fuses for protecting the equipments from an overcurrent increases, becoming one of the factors hindering the electrical connection boxes from becoming smaller and more lightweight.

As shown in FIG. 23, further, input-side busbars 231 each arranged between one of terminals at the opposite sides of a fuse 230 and a power source (battery) are generally connected one by one with the respective fuses 230 in parallel. Such a connecting circuit is adopted because the respective fuses 230 are not constructed to be independent and connectable with each other.

Thus, the number of the input-side busbars increases as the number of the fuses increases as a result of the increase in the comfortable equipments as mentioned above, making it difficult to make the electrical connection box smaller.

### SUMMARY OF THE INVENTION

It is an object of the present invention to provide a fuse, a fuse mounting structure, and a fuse circuit which have overcome the problems residing in the prior art.

According to an aspect of the invention, notches are formed in a covering member for covering a fuse main body. Leading ends of a connecting member are insertable into the notches. High insulation can be ensured by suppressing the exposing degree of connection terminals, and the height of the fuse in its mounted state can be shortened.

According to another aspect of the invention, input terminals are connected in parallel upon being shorted by a shorting member, and it is sufficient to connect one of these input terminals with an input-side busbar connected with the common power source. Thus, the number of the input-side busbars can be reduced, with the result that an electrical connection box can be made substantially smaller.

These and other objects, features and advantages of the present invention will become more apparent upon a reading of the following detailed description and accompanying drawings.

### BRIEF DESCRIPTION OF THE DRAWINGS

FIG. 1 is a perspective view showing an external configuration of a fuse according to a first embodiment of the invention;

FIG. 2A is a front view showing a mounted state of the fuse is mounted;

FIG. 2B is a bottom view of the fuse in this state;

FIG. 2C is a section taken along the line 2C-2C in FIG. 2A;

FIG. 3 is a perspective view showing a fuse according to a second embodiment of the invention;

FIG. 4 is a perspective view showing an external configuration of a fuse mounting structure of an electrical connection box according to a third embodiment;

FIG. 5A is a plan view showing an essential portion of the fuse mounting structure of the electrical connection box;

FIG. 5B is a section taken along the line 5B-5B in FIG. 5A;

FIG. 5C is a section taken along the line 5C-5C in FIG. 5A;

FIG. 6 is a perspective view showing an external configuration of a fuse mounting structure of an electrical connection box according to a fourth embodiment;

FIG. 7A is a plan view showing an essential portion of the fuse mounting structure of the electrical connection box according to the fourth embodiment;

FIG. 7B is a section taken along the line 7B-7B in FIG. 7A;

FIG. 7C is a section taken along the line 7C-7C in FIG. 7A;

FIG. 8 is a perspective view showing an external configuration of another fuse mounting structure of the electrical connection box according to the fourth embodiment;

FIG. 9A is a plan view showing an essential portion of the another fuse mounting structure of FIG. 8;

FIG. 9B is a section taken along the line 9B-9B in FIG. 9A;

FIG. 9C is a section taken along the line 9C-9C in FIG. 9A;

FIG. 10 is an exploded perspective view showing a fuse and a portion neighboring the fuse which form an essential portion of a fuse circuit according to a fifth embodiment of the invention;

FIG. 11 is an exploded perspective view of the essential portion of the fuse circuit of FIG. 10 when being viewed from the opposite side;

FIG. 12 is an equivalent circuit diagram of the fuse circuit of FIG. 10;

FIG. 13 is a plan view showing a part of an electrical connection box in which fuses of FIG. 10 or 11 are mounted;

FIG. 14 is a plan view enlargedly showing the part of FIG. 13;

FIG. 15 is a plan view of the part of FIG. 13,

FIG. 16 is a right side view of the part of FIG. 13,

FIG. 17A is a plan view showing a protection cover for protecting fuses and shorting members;

FIG. 17B is a right side view of the protection cover of FIG. 17A;

FIG. 18 is a front view of another fuse according to the invention;

FIG. 19 is a perspective view showing an external configuration of a conventional electrical connection box;

FIG. 20 is a perspective view showing a state where a conventional fuse is mounted in press-contact blades;

FIG. 21 is an exploded perspective view showing the conventional electrical connection box;

FIG. 22 is a perspective view showing a conventional general fuse; and

FIG. 23 is an equivalent circuit diagram showing an exemplary fuse circuit.

### DETAILED DESCRIPTION OF THE PREFERRED EMBODIMENTS OF THE INVENTION

Several embodiments of the present invention will be described with reference to the drawings.

(First Embodiment)

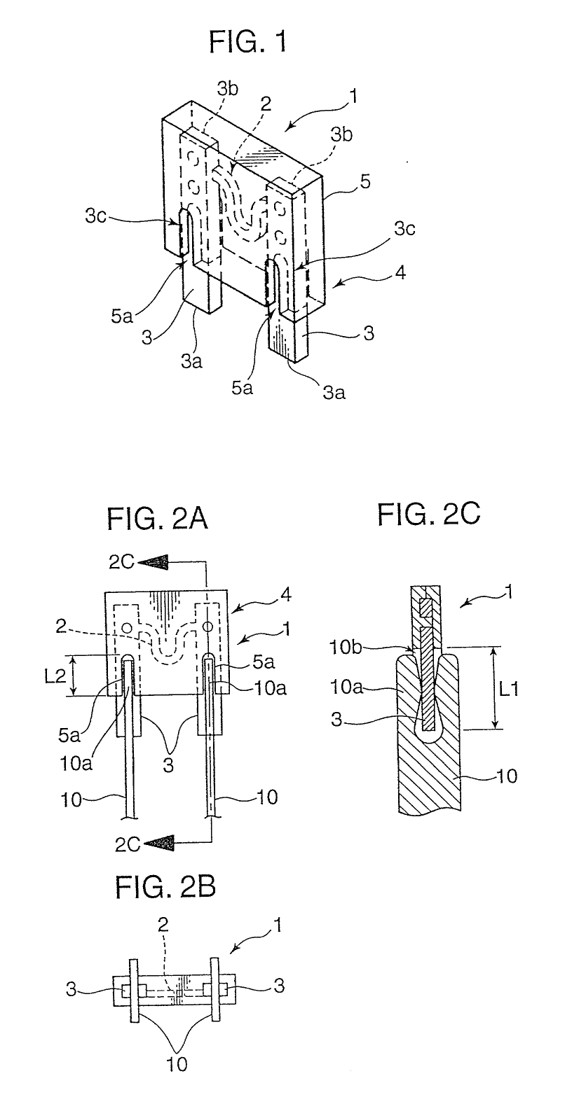

Referring to FIG. 1 showing an external configuration of an exemplary fuse according to a first embodiment of the invention, a fuse 1 includes a fuse main body 4 made of a conductor in which connection terminals 3 are provided at the opposite ends of a fusing portion 2, and a covering member 5 for covering the fuse main body 4 while partly exposing the connection terminals 3.

The fusing portion 2 melts when an overcurrent of a specified level or higher flows, and is a curved punched-out metal piece in this embodiment. The opposite ends of the fusing portion 2 are coupled to the connection terminals 3 made of a hard electrically conductive material. The two connection terminals 3 are rectangular pieces parallel with each other, and the base ends (upper ends in FIG. 1) thereof are connected with each other via the fusing portion 2.

The covering member 5 is made of an insulating resin material and has such a substantially rectangular shape as to expose the leading ends 3a (ends opposite from the base ends 3b) of the connection terminals 3, i.e., to cover the base ends 3b of the connection terminals 3 and the fusing portion 2. Further, notches 5a in the form of narrow slits extending upward from the bottom end of the covering member 5 are formed as first notches at portions of the covering member 5 corresponding to intermediate sections 3c of the connection terminals 3, and the intermediate sections 3c of the connection terminals 3 are exposed to outside through the notches 5a.

This fuse 1 is mounted into connection with press-contact blades as shown in FIGS. 2A to 2C. FIG. 2A is a front view showing a mounted state of the fuse 1, FIG. 2B is a bottom view of the fuse 1 in the mounted state, and FIG. 2C is a section taken along the line 2C-2C in FIG. 2A.

A forked inserting portion 10b is provided at a leading end 10a of each press-contact blade 10a, and the connection terminal 3 and the press-contact blade 10 are electrically connected by inserting (mounting) the connection terminal 3 of the fuse 1 into the inserting portion 10b. The width of the notches 5a formed in the covering member 5 are set substantially equal to the thickness of the press-contact blades 10 so that the leading ends 10a of the press-contact blades 10 are insertable into the notches 5a.

Since the insulating covering member 5 is present at the lateral sides of the notches 5a in the fuse 1 of the first embodiment, high insulation can be ensured while suppressing an exposing degree of the connection terminals 3. Particularly in the case that the width of the notches 5a is set substantially equal to the thickness of the press-contact blades 10, an exposed area of the connection terminals 3 can be further smaller. Further, if the fuse 1 is so mounted as to have an engaging length L1 as shown in FIG. 20 (see FIG. 2), the length of the connection terminals 3 can be shortened by a length L2 of the notches 5a, with the result that the height of the fuse 1 itself can be shortened. Furthermore, since the leading ends 10a of the press-contact blades 10 are inserted into the notches 5a, the height of the fuse 1 in its mounted state can be shorted, thereby enabling an electrical connection box to be substantially smaller.

(Second Embodiment)

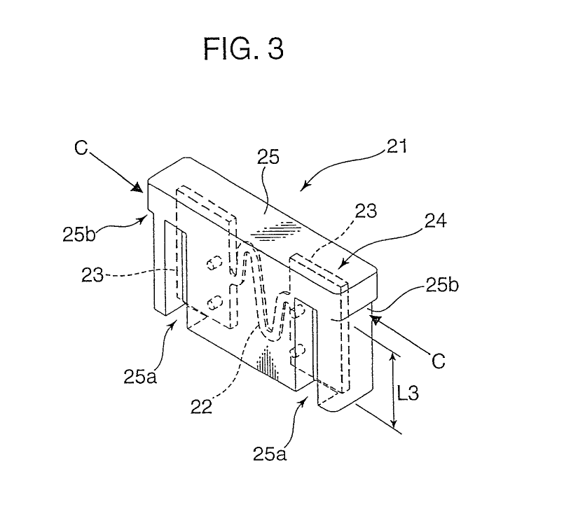

FIG. 3 is a perspective view showing an exemplary fuse according to a second embodiment of the present invention. This fuse 21 includes a fuse main body 24 in which connection terminals 23 are coupled at the opposite ends of a fusing portion 22, and an insulating covering member 25 for covering the entire fuse main body 24 excluding notches 25a. Only sections of the connection terminals 23 exposed through the notches 25a function as connecting portions to be connected with press-contact blades. A length L3 of the notches 25a is substantially equal to the engaging length L1, and the width thereof is set substantially equal to the thickness of the press-contact blades, thereby making an exposed area of the connection terminals 23 smaller. Further, stepped portions 25b used to pull the fuse 21 out are formed on the opposite side surfaces of the covering member 25 (with respect to directions C). How these stepped portions 25b function is described later.

Since the insulating covering member 25 is present at the lateral sides of the notches 25a in the fuse 21 of the second embodiment, high insulation can be ensured while suppressing an exposing degree of the connection terminals 23. Further, if the fuse 21 is so connected with press-contact blades similar to the aforementioned ones as to have the engaging length L1, the length of the connection terminals 23 can be shortened by length L3 (˜L) of the notches 25a, with the result that the height of the fuse 21 itself can be made equal to that of the covering member 25. Thus, the height of the fuse 21 can be made fairly shorter. Furthermore, since the leading ends of the press-contact blades are inserted into the notches 25a, the height of the fuse 21 in its mounted state can be shorted, thereby enabling an electrical connection box to be substantially smaller.

(Third Embodiment)

Next, a fuse mounting structure of an electrical connection box in which the inventive fuses are suitably mountable is described.

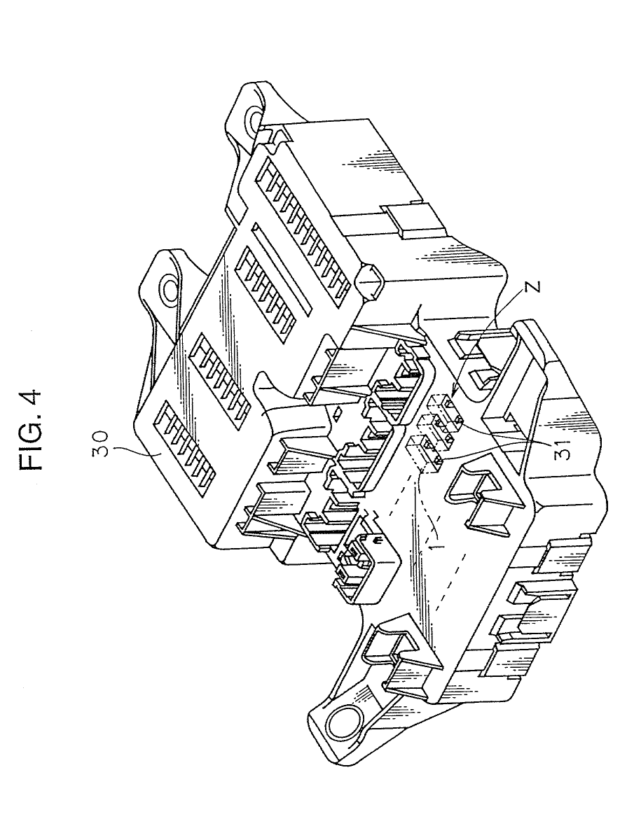

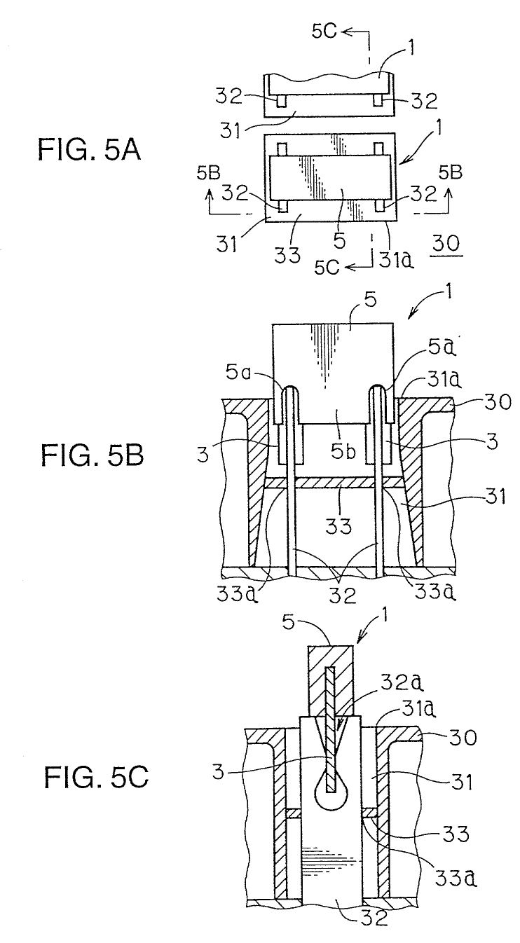

FIG. 4 is a perspective view showing the external configuration of an exemplary fuse mounting structure of the electrical connection box; FIG. 5A is a plan view showing an essential portion (see FIG. 4) of the fuse mounting structure, FIG. 5B is a section taken along the line 5B-5B in FIG. 5A, and FIG. 5C is a section taken along the line 5C-5C in FIG. 5A. It should be noted that the fuse 1 of the first embodiment is used in FIGS. 4 and 5.

This electrical connection box 30 is formed with mount holes 31 used to mount the fuses 1, and two press-contact blades 32 as leading ends of busbars are so provided inside each mount hole 31 as to project outwardly (upwardly in FIGS. 4 and 5). Base ends (ends thereof opposite from the press-contact blades 32) of these busbars are electrically connected with unillustrated circuits. Forked inserting portions 32a are provided at the leading ends (upper ends) of the press-contact blades 32, and the leading ends thereof project slightly more upward than opening edges 31a of the mount holes 31. Inside each mount hole 31, a partition wall 33 for partitioning the mount hole 31 into inner and outer sections is integrally or unitarily formed with the inner walls of the mount hole 31. Two press-contact blade insertion holes 33a are formed in the partition wall 33, and intermediate portions of the press-contact blades 32 are introduced through the press-contact blade insertion holes 33a.

The fuse 1 is mounted in this electrical connection box 30 as follows. First, the connection terminals 3 of the fuse 1 are inserted into the inserting portions 32a of the press-contact blades 32. At this time, since the leading ends of the press-contact blades 32 project more upward than the opening edge 31a of the mount hole 31, the fuse 1 can be inserted with the leading ends of the press-contact blades 32 as a guide, making positioning of the fuse 1 easier. Thereafter, the connection terminals 3 are inserted into the inserting portions 32a. Since the press-contact blades 32 are introduced through the press-contact blade insertion holes 33a during this insertion, it prevents the press-contact blades 32 from shaking. Further, by setting the width of the notches 5a substantially equal to the thickness of the press-contact blades 32, the notches 5a function as a guide to be guided by the press-contact blades 32.

Thereafter, a bottom end 5b of the covering member 5 of the fuse 1 enters the mount hole 31, and the leading ends of the press-contact blades 32 come into contact with the inner back ends of the notches 5a of the fuse 1, making further insertion of the fuse 1 impossible. This contact position defines a maximum insertion depth of the fuse 1. In this way, mounting of the fuse 1 in the electrical connection box 30 is completed. Accordingly, the fuse 1 and the circuit built in the electrical connection box 30 are electrically connected via the busbar part of which is the press-contact blades 32, thereby preventing this circuit from being damaged by an overcurrent. It should be noted that the partition wall 33 is provided at a position located more deeply than the maximum insertion depth.

In the case that the electrical connection box takes such a fuse mounting structure, following effects can be obtained in addition to the effects of the fuse 1 itself. Specifically, since the bottom end 5b of the covering member 5 of the fuse 1 enters the mount hole 31 with the connection terminals 3 electrically connected with the press-contact blades 32, the height of the fuse 1 can be made shorter with the fuse 1 mounted in the electrical connection box 30, thereby enabling the electrical connection box 30 to be substantially smaller.

If the fuse 21 of the second embodiment is used in the third embodiment, following effects can be obtained in addition to an advantage that the height of the electrical connection box 30 can be made even shorter as compared to a case where the fuse 1 of the first embodiment is used. Specifically, since the stepped portions 25 for pulling the fuse 21 out are formed on the opposite side surfaces (with respect to directions C) of the covering member 25 of the fuse 21 as shown in FIG. 3, the fuse 21 connected with the press-contact blades can be easily pulled out by holding the both stepped portions 25b using, for example, a puller (fuse pulling device). A spacing between adjacent fuses, i.e., an arrangement interval of the prior art fuses cannot be made narrower since the fuses are pulled out by being held in directions B normal to directions C using a puller as shown in FIG. 20. If the fuses 21 of the second embodiment are used, the fuse arrangement interval can be made narrower. If the prior art fuses shown in FIG. 20 are used, the fuse arrangement interval is thought to be smaller in directions (directions C) normal to directions B since the fuses are held by the puller in directions B. However, since the press-contact blades actually form the leading ends of the busbars, the fuse arrangement interval cannot be made narrower even in directions C if the arrangement of the busbars is considered. Contrary to this, since the fuse arrangement interval is made narrower in directions (directions B) normal to directions C in this embodiment, it can be made narrower in the widthwise direction of the busbars.

(Fourth Embodiment)

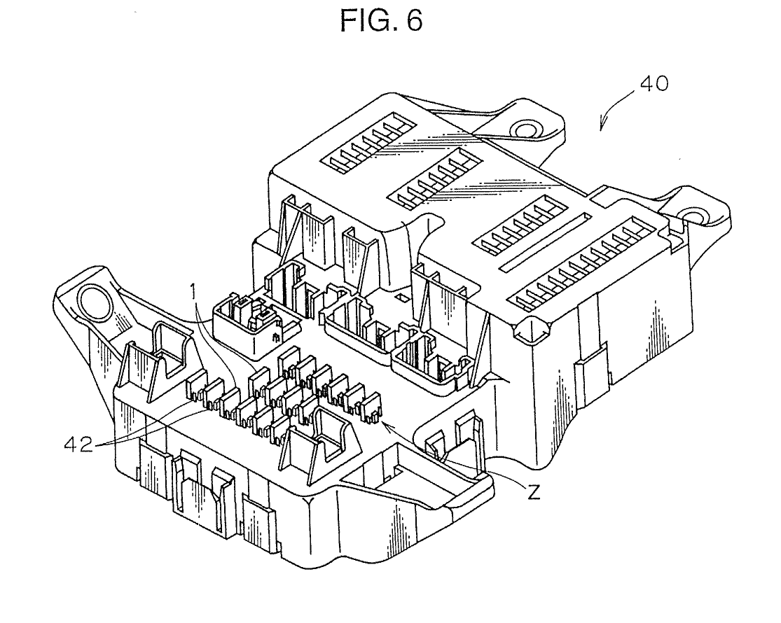

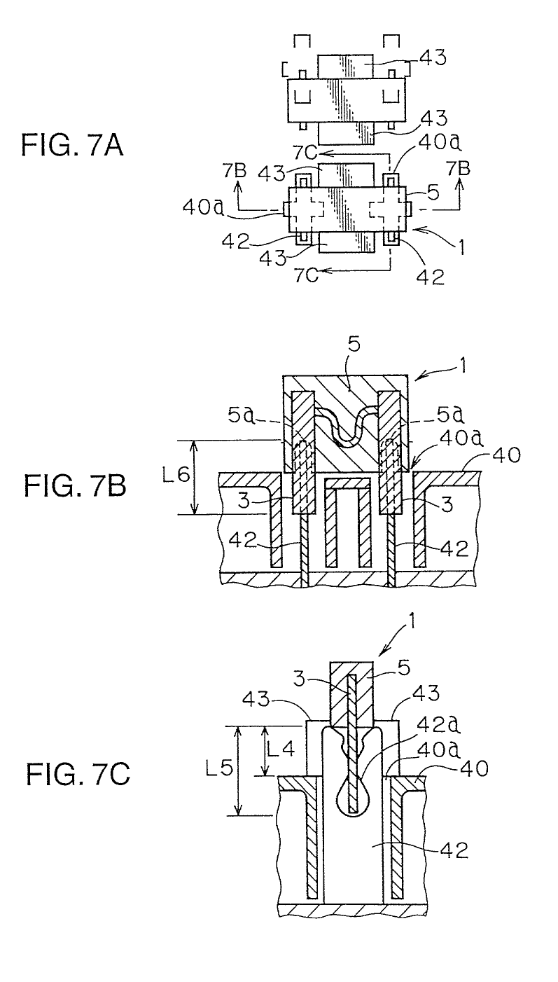

FIG. 6 is a perspective view showing the external configuration of an exemplary fuse mounting structure of an electrical connection box according to a fourth embodiment; FIG. 7A is a plan view showing an essential portion (see FIG. 23) of the fuse mounting structure, FIG. 7B is a section taken along the line 7B-7B in FIG. 7A, and FIG. 7C is a section taken along the line 7C-7C in FIG. 7A. It should be noted that the fuse 1 of the first embodiment is used in FIGS. 6 and 7.

In this electrical connection box 40, two press-contact blades 42 as leading ends of busbars penetrate and project through each press-contact blade/connection terminal insertion holes 40a formed in the electrical connection box 40 from inner side to outer side, and a length L4 of the leading ends of the press-contact blades 42 projecting from the outer surface of the electrical connection box 40 is set substantially equal to the length L2 of the notches 5a. Further, a length L5 of inserting portions 42a of the press-contact blades 42 is sufficiently longer than the length L4 while being slightly longer than a length L6 of sections of the connection terminals 3 from the inner back ends of the notches 5a to their leading ends. Fuse holding ribs 43 project from the outer surface of the electrical connection box 40 at such positions where they are in contact with the covering members 5 of the fuses 1.

The fuse 1 is mounted in this electrical connection box 40 as follows. As the connection terminals 3 of the fuse 1 are inserted into the inserting portions 42a of the press-contact blades 42, the upper ends of the press-contact blades 42 come into contact with the inner back ends of the notches 5a, i.e., the connection terminals 3 are inserted until the bottom end of the covering member 5 comes into contact with the outer surface of the electrical connection box 40. In this inserted state, the connection terminals 3 are located in the press-contact blade/connection terminal insertion holes 40a. After the fuse 1 is mounted, the covering member 5 is held in contact with the fuse holding ribs 43.

Accordingly, in the case of adopting the fuse mounting structure of the electrical connection box according to the fourth embodiment, following effects can be obtained in addition to the effects of the fuse 1 itself. Specifically, since the fuse 1 is inserted until the bottom end 5b of the covering member 5 of the fuse 1 comes into contact with the outer surface of the electrical connection box 40 (i.e., the connection terminals 3 enter the insertion holes 40a), the height of the fuse 1 can be made shorter while being mounted in the electrical connection box 40, thereby making the electrical connection box 40 substantially smaller. Further, since the leading ends of the press-contact blades 42 project from the outer surface of the electrical connection box 40, the connection terminals 3 can be inserted into the press-contact blades 42 with the leading ends of the press-contact blades 42 as a guide, making positioning of the fuse 1 easier. Furthermore, even if an external force acts on the mounted fuse 1, the ribs 43 can suppress a displacement of the fuse 1 caused by this external force.

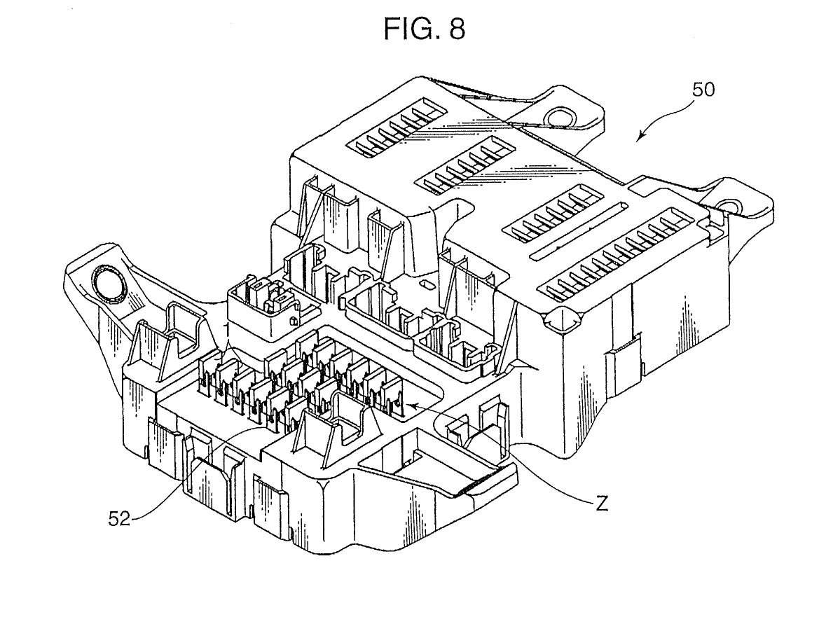

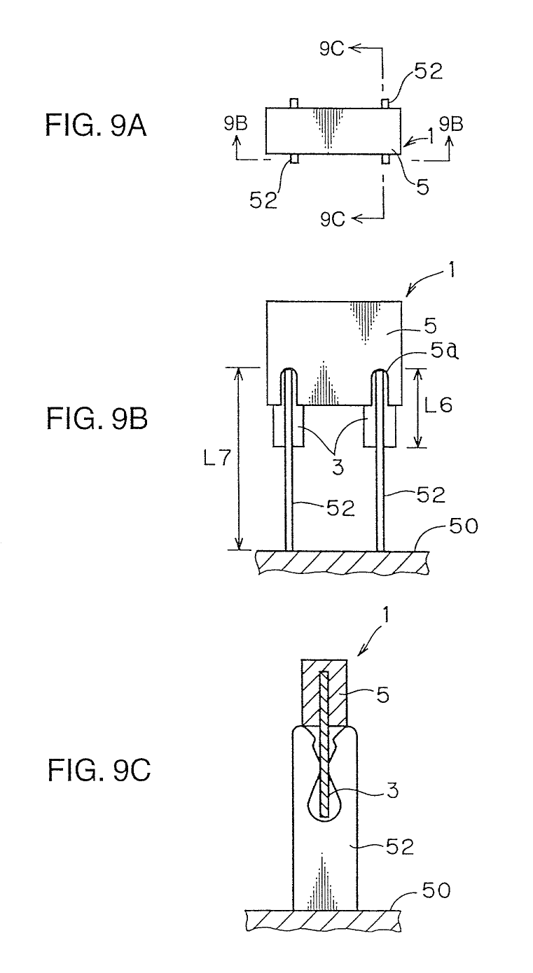

Although the fuse 1 is inserted until the bottom end 5b of the covering member 5 comes into contact with the outer surface of the electrical connection box 40 in the fourth embodiment, the present invention is not limited thereto. A fuse mounting structure of an electrical connection box as shown in FIGS. 8 and 9 may also be adopted.

FIG. 8 is a perspective view showing the external configuration of another exemplary fuse mounting structure of an electrical connection box according to the fourth embodiment; FIG. 9A is a plan view showing an essential portion of the fuse mounting structure of FIG. 8, FIG. 9B is a section taken along the line 9B-9B in FIG. 9A, and FIG. 9C is a section taken along the line 9C-9C in FIG. 9A. It should be noted that the fuse 1 of the first embodiment is used in FIGS. 8 and 9.

In this electrical connection box 50, two press-contact blades 52 as leading ends of busbars project from the electrical connection box 50 so as to correspond to each fuse 1, and a length L7 between the leading ends of the press-contact blades 52 and the outer surface of electrical connection box 50 is set sufficiently longer than the length L6 of the sections of the connection terminals 3 from the inner back ends of the notches 5a to their leading ends.

Since the leading ends of the press-contact blades 52 enter the notches 5a of the covering member 5 in this mounting structure as in the former mounting structure, the height of the fuse 1 in its mounted state can be made smaller, thereby making the electrical connection box 50 substantially smaller. If the fuse 21 of the second embodiment is used, following effects can be obtained in addition to an advantage that the height of the electrical connection box 30 can be made even shorter as compared to a case where the fuse 1 of the first embodiment is used. As in the third embodiment, the fuse 21 can be easily pulled out by holding the stepped portions 25 using, for example, a puller, and the fuse arrangement interval can be made narrower.

Although the fuse is mounted in the electrical connection box in the third and fourth embodiments, the present invention is not limited thereto. For example, the present invention is applicable to a connection casing which is an outermost casing of the electrical connection box, specifically to a construction including circuits and busbars or like connecting members having one ends thereof connected with the circuits and having forked inserting portions formed at the other ends thereof and caused to expose from the casing.

(Fifth Embodiment)

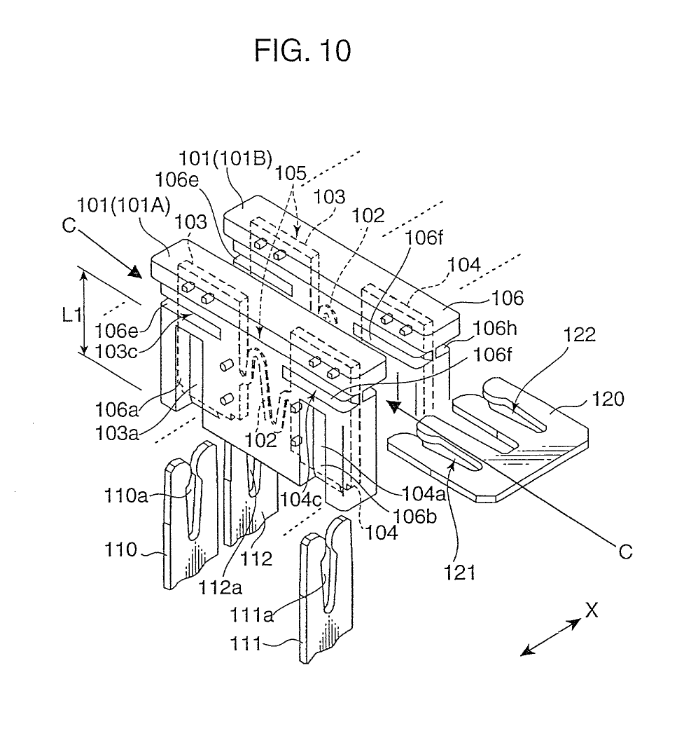

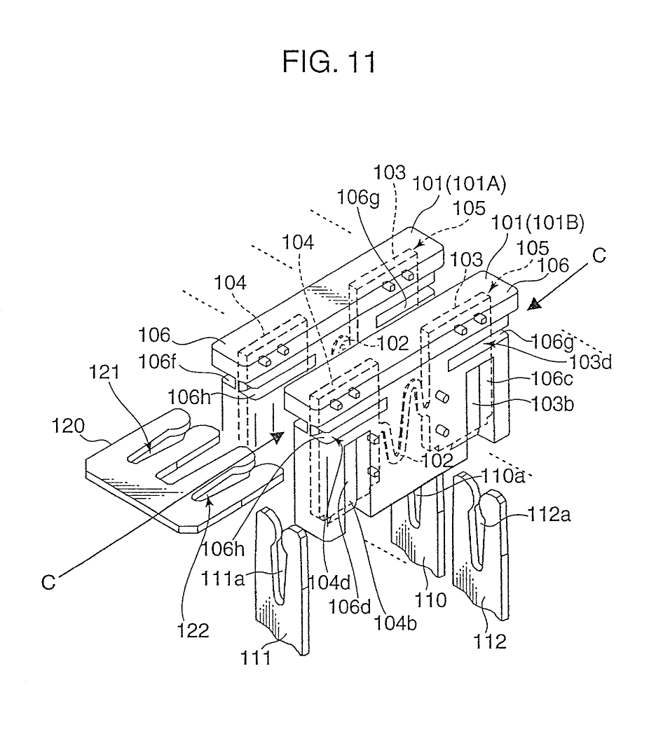

FIG. 10 is an exploded perspective view showing a fuse and a portion neighboring the fuse which form an essential portion of a fuse circuit according to a fifth embodiment of the present invention, and FIG. 11 is an exploded perspective view of the essential portion of the fuse circuit of FIG. 10 when being viewed from the opposite side.

The fuse circuit of this embodiment is constructed by combining a plurality of fuses 101, tab terminals 110, 111, 112 to be connected with the fuses 101, and a shorting member 120 made of an electrically conductive material and including two comb-shaped press-contact blades 121, 122.

The fuse 101 includes a plate-shaped fuse main body 105 in which an input terminal 104 and an output terminal 103 are coupled to the opposite ends of a fusing portion 102, and an insulating member 106 for covering the fuse main body 105 excluding part thereof. The respective fuses 101 are of the same mode excluding a fusing characteristic of the fusing portion 102, i.e., fuse capacity, and substantially in the form of a rectangular parallelepiped. The fuse main body 105 is located substantially in the middle of the insulating member 106 with respect to widthwise direction, and first notches 106a, 106b, 106c, 106d are formed in the surfaces of the insulating member 106 at the opposite sides of the fuse main body 105 to extend vertically and reach the bottom end of the insulating member 106.

The first notches 106a, 106c are formed in the same shape and in the same size at positions symmetrical with respect to the fuse main body 105 at the left side of the fuse 101 in FIG. 10, and the first notches 106b, 106d are formed in the same shape and in the same size at positions symmetrical with respect to the fuse main body 105 at the right side of the fuse 101 in FIG. 10. The first notches 106a, 106b and the first notches 106c, 106d are also formed in the same shape and in the same size. Connecting portions 103a, 104a in the middle of the bottom ends of the two terminals 103, 104 are exposed through the first notches 106a, 106b, and connecting portions 103b, 104b in the middle of the bottom ends of the two terminals 103, 104 are exposed through the first notches 106c, 106d.

Further, second notches 106e, 106f, 106g, 106h in the form of an oblong slit used as inserting portions for the comb-shaped press-contact blades 121, 122 are formed in the surfaces of the insulating member 106 at the opposite sides of the fuse main body 105 to extend in a direction in which the two terminals 103, 104 are spaced apart (transverse direction). The second notches 106e, 106g are formed in the same shape and in the same size at positions symmetrical with respect to the fuse main body 105 to reach the left surface of the fuse 101 at the left side of the fuse 101 in FIG. 10, and the second notches 106f, 106h are formed in the same shape and in the same size at positions symmetrical with respect to the fuse main body 105 to reach the right surface of the fuse 101 at the right side of the fuse 101 in FIG. 10.

Sections 103c, 104c of the two terminals 103, 104 in the middle with respect to height direction are substantially entirely exposed through the second notches 106e, 106f, and sections 103d, 104d of the two terminals 103, 104 in the middle with respect to height direction are substantially entirely exposed through the second notches 106g, 106h.

Forked inserting portions 110a, 111a, 112a are formed at the upper ends of the respective tab terminals 110, 111, 112. The inserting portions 110a of the tab terminal 110 is inserted into the first notches 106a, 106c of the fuse 101A at the front side of FIG. 10, the inserting portion 111a of the tab terminal 111 is inserted into the first notches 106b, 106d of the fuse 101A, and the inserting portion 112a of the tab terminal 112 is inserted into the first notches 106a, 106c of the fuse 101B at the back side of FIG. 10. Thus, the outer terminal 103 of the front fuse 101A and the tab terminal 110 are connected, the input terminal 104 of the front fuse 101A and the tab terminal 111 are connected, and the output terminal 103 of the rear fuse 101B and the tab terminal 112 are connected. It should be noted that no tab terminal is connected at the first notches 106b, 106d of the rear fuse 101B.

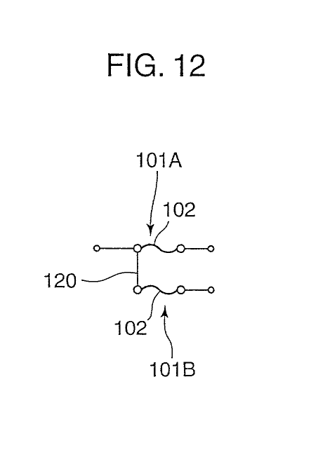

The shorting member 120 is comprised of the two comb-shaped press-contact blades 121, 122 in the shown example as described above. One comb-shaped press-contact blade 121 is inserted into the second notches 106f, 106h of the front fuse 101A to connect the input terminal 104 of the fuse 101A and the press-contact blade 121, whereas the other comb-shaped press-contact blade 122 is inserted into the second notches 106f, 106h of the rear fuse 101B to connect the input terminal 104 of the fuse 101B and the press-contact blade 122. Thus, the input terminal 104 of the front fuse 101A and the input terminal 104 of the rear fuse 101B are electrically connected via the shorting member 120. As a result, a fuse circuit in which the two fuses 101A, 101B and the respective fusing portions 102 are connected in parallel is constructed as shown in FIG. 12.

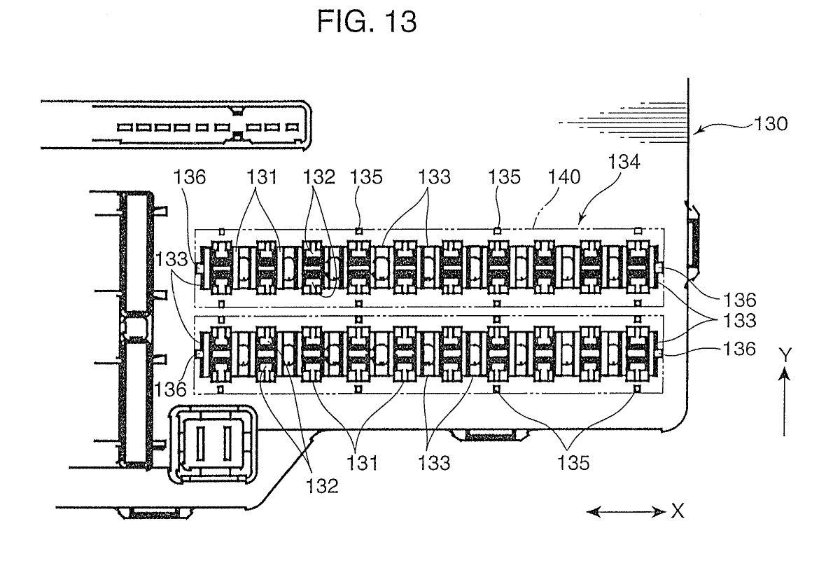

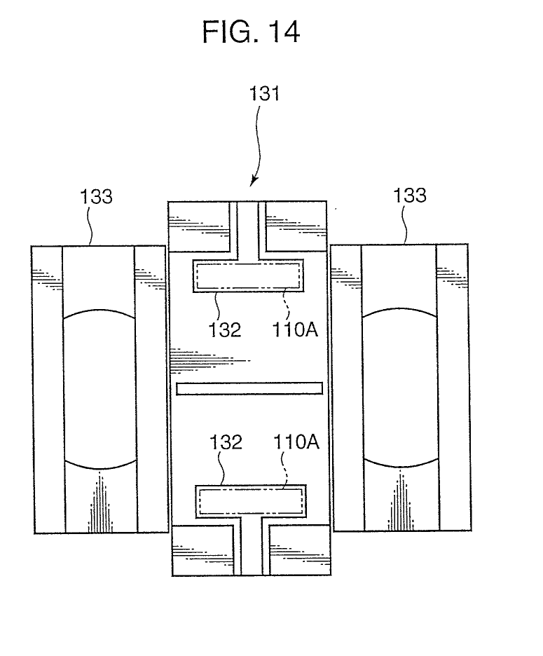

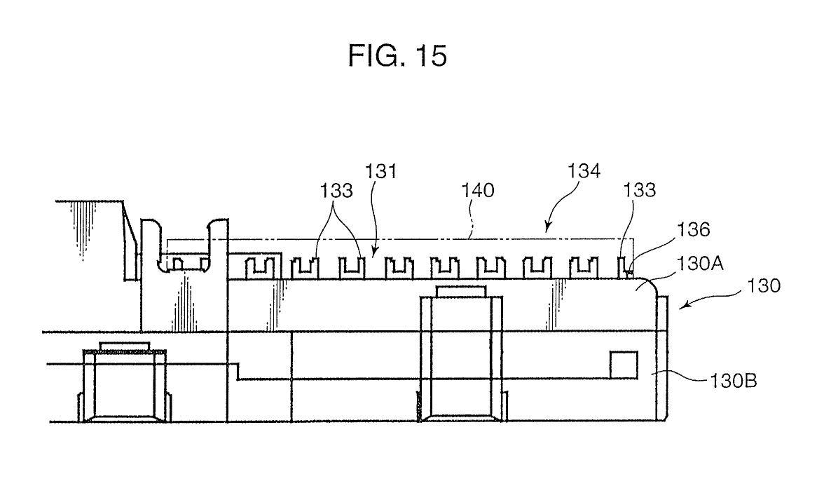

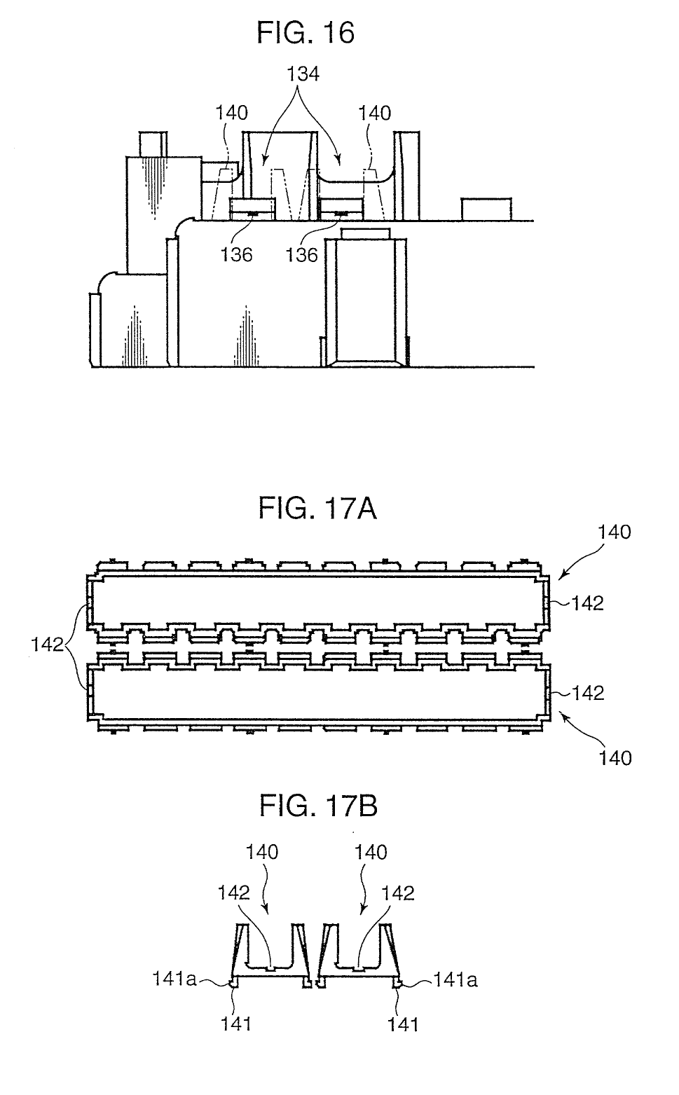

FIG. 13 is a plan view showing part of an electrical connection box in which fuses of FIG. 10 or 17 are mounted; FIG. 14 is a plan view enlargedly showing part of FIG. 13; FIG. 15 is a plan view of FIG. 13; FIG. 16 is a right side view of FIG. 13; FIG. 17A is a plan view showing a protection cover for protecting the fuses and the shorting members, and FIG. 17B is a right side view of the protection cover of FIG. 17A.

On the upper surface of an electrical connection box 130, a multitude of mount portions 131 are arrayed at specified intervals in X-direction (10 mount portions 131 in the shown example) and in two rows in Y-direction. The fuse 101 is mounted into each mount portion 131 with the widthwise direction of the fuse 101 aligned with X-direction and with the longitudinal direction (spaced-apart direction of the two connection terminals) thereof aligned with Y-direction. Projections 133 for holding the respective mounted fuses 101 from opposite sides along X-direction are provided between adjacent fuses 101 and at the outer sides of the fuses 101 at the opposite ends. In other words, the fuses 101 are mounted in the mount portions 131 by inserting the fuses 101 between the projections 133.

Tab terminals 110A corresponding to the tab terminals 110 to 112 are inserted into each mount portion 131 through tab terminal insertion holes 132 formed in a recess 131 from below as shown in FIG. 14. Specifically, the electrical connection box 130 is constructed by placing an upper connection casing 130A and a lower connection casing 130B one over the other as shown in FIG. 15. The tab terminals 110A formed by bending up ends of busbars (not shown) arranged in a specified pattern on the upper surface of the lower connection casing 130B project up through the two tab terminal insertion holes 132 provided in each mount portion 131 of the upper connection casing 130A by a specified length: at least length L1 of the first notches 106a to 106d as shown in FIG. 10 by placing the upper connection casing 130A on the lower connection casing 130B. The tab terminals 110A project at once by placing the two connection casings 130A, 130B one over the other. However, no tab terminal projects through the tab terminal insertion holes 132 which require no connection of the tab terminals as a matter of course.

When the fuses 101 are inserted into the respective mount portions 131 where the tab terminals project out, the two terminals 103, 104 of the fuses 101 are inserted into the forked inserting portions of the tab terminals in the respective mount portions 131 to connect the output terminals 103 and the input terminals 104 with the corresponding tab terminals. At this time, since the input terminal 104 and the output terminal 103 are symmetrically formed in the fuse 101 of this embodiment, the fuse 101 can be mounted into the mount portion 131 without considering the positions of the two terminals 103, 104 and the terminal connected with the shorting member 120 can be simply used as an input terminal.

If the shorting member 120 is mounted sideways as shown in FIG. 10 to be connected with a pair of fuses 101 among a multitude of fuses 101 mounted in the respective mount portions 131, the fusing portions 102 of the pair of fuses 101 are connected in parallel.

Protection covers 140 shown in FIG. 17 are mounted on the connection casing 130A of the electrical connection box 130 in such a state as shown in phantom line in FIGS. 13, 15 and 16. Each protection cover 140 has a length corresponding to the number of the fuses 101 arrayed in one row, and has such a shape as to surround the fuses 101 and the shorting members 120 at a specified spacing therefrom in plan view, for example, when the shorting member 120 is mounted into connection with a pair of fuses 101.

On the other hand, as shown in FIG. 13, a plurality of (8 in the shown example) mount holes 135 are provided in each mount area 134 of the electrical connection box 130 where the protection cover 140 is mounted, and the projections 133 at the opposite ends are provided with locking claws 136 as shown in FIGS. 13, 15 and 16. On the other hand, hook-shaped inserting portions 141 each having a projection 141a to be inserted into the corresponding mount hole 135 are provided at positions of a bottom surface 140a of the protection cover 140 corresponding to the mount holes 135, and engaging recesses 142 are formed at upper ends 140b at the opposite ends of the bottom surface 140a as shown in FIG. 17B.

When the protection cover 140 is mounted on the electrical connection box 130, the hook-shaped inserting portions 141 are inserted into the mount holes 135, and the locking claws 136 are engaged with the engaging recesses 142. At this time, since the mount holes 135 are through holes formed in the upper wall of the hollow electrical connection box 130, the projections 141a of the hook-shaped inserting portions 141 are engaged with the edges of the inner surfaces of the mount holes 135. In this way, the protection cover 140 is so mounted on the electrical connection box 130 as not to disengage therefrom.

As described above, in the fuse circuit of this embodiment, the input terminals 104 connected with a common power source are connected in parallel upon being shorted by the shorting member 120 and it is sufficient to connect only one of the input terminals 104 with the input-side busbar. Thus, the number of the input-side busbars can be reduced. As a result, the electrical connection box 130 can be made substantially smaller. Further, the busbars used can have a simple shape having a small number of connecting portions with the fuse 101, and a design change can be easily dealt with by shorting the fuses 101. Further, since the second notches 106e to 106h are each formed such that one end thereof reaches the side surface of the fuse 101, the fusing portions 102 can be easily connected in parallel only by inserting the shorting member 120 into the second notches 106e to 106h. Furthermore, since the fuses 101 are arrayed at the specified intervals in X-direction substantially normal to the spaced-apart direction of the two terminals 103, 104 and the comb-shaped press-contact blades 121, 122 of the shorting member 120 are spaced apart by the same distance as the specified interval, the shorting terminal 120 is mounted into connection with an arbitrary pair of those of a plurality of fuses 101 arrayed in X-direction, i.e., it does not matter where the shorting terminal 120 is mounted. Further, since the protection cover 140 is made of an insulating material and surrounds the fuses 101 and the shorting member 120 connected with the input terminals 104 of the fuses 101, it can prevent an external force from acting on the fuses 101 and the shorting members 120 and protect an insulated state of the fuses 101 and the shorting members 120 from outside. Furthermore, since the protection covers 140 are provided for the respective rows of the fuses 101, they can prevent the fuses 101 of one row and those of the other row, the shorting members 101 of one row and those of the other row, and the fuses 101 of one row and the shorting terminals 120 of the other row from being shorted.

Further, with the fuses 101 of the fifth embodiment, the input terminals 104 are connected in parallel upon being shorted by the shorting member 120, and it is sufficient to connect one of the input terminals 104 with the busbars connected with a common power source. Thus, the number of the input-side busbars can be reduced. As a result, the electrical connection box 130 can be made substantially smaller. Further, the busbars used can have a simple shape having a small number of connecting portions with the fuse 101, and a design change can be easily dealt with by shorting the fuses 101. Further, the insulating member 106 is provided with the first notches 106a to 106d for connecting the respective terminals 103, 104 with the busbars and the connecting portions 103a, 103b, 104a, 104b are exposed through the first notches 106a, 106d, the length of the two terminals 103, 104 can be shortened. Since the first notches 106a to 106d are formed in the insulating member 106, the insulating member 106 can be lighter and smaller. Further, since the connecting portions 103a, 103b, 104a, 104b are located at the first notches 106a to 106d, the height of the fuse 101 itself and that of the fuse 101 in its mounted state can be lower.

Furthermore, since the second notches 106e to 106h are formed at the opposite ends of the fuse 101 of the fifth embodiment, the fuse 101 can be pulled by being held in directions C-C (see FIGS. 10 and 11) which is the spaced-apart direction of the two connection terminals 103, 104 by means of a fuse pulling device (puller), taking advantage of the second notches 106e to 106h. The prior art fuse 210 is pulled upward by being held by fingers in directions B-B normal to directions C-C as shown in FIG. 20 and, accordingly, the fuses 210 cannot be brought closer to each other in widthwise direction (X-direction). However, since the fuses 101 of this embodiment can be pulled by the fuse pulling device, they can be brought closer in widthwise direction (X-direction), enabling a more compact arrangement of the fuses 101.

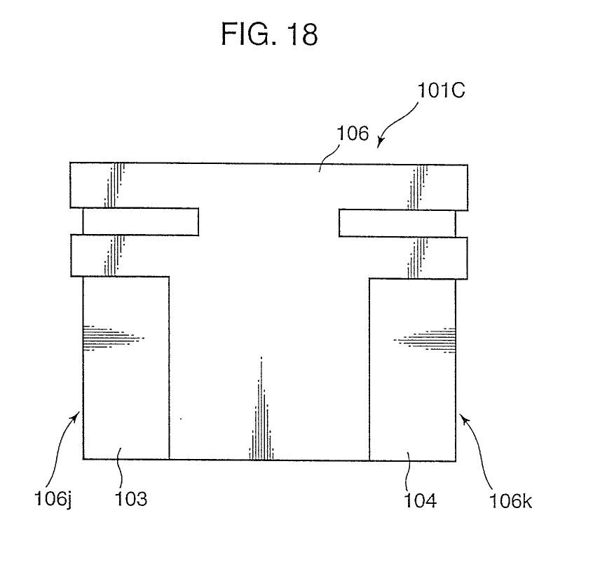

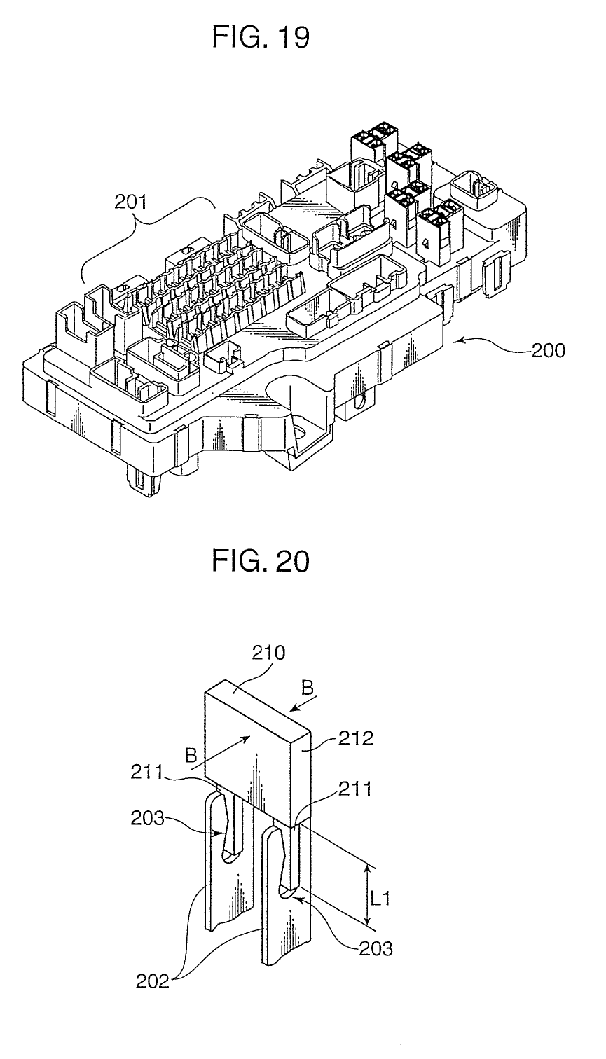

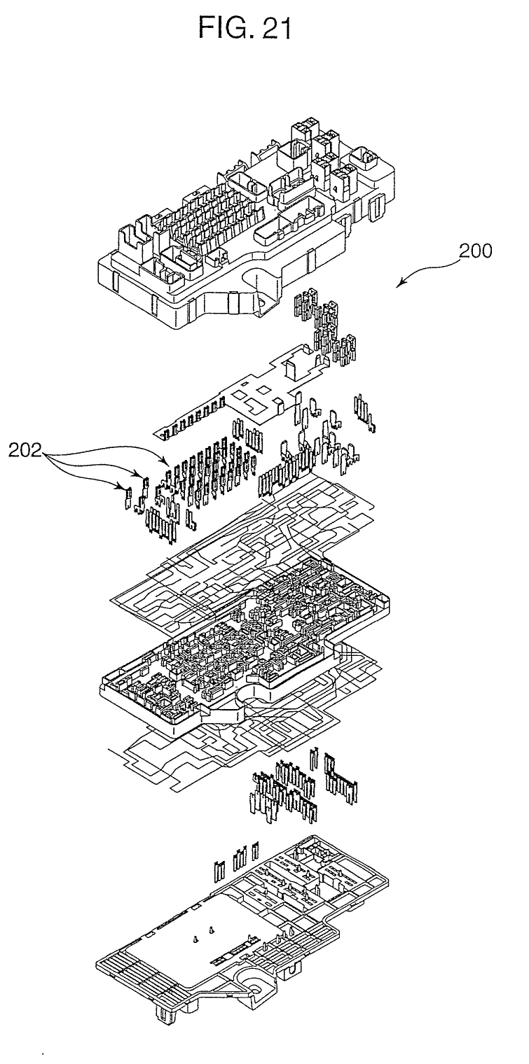

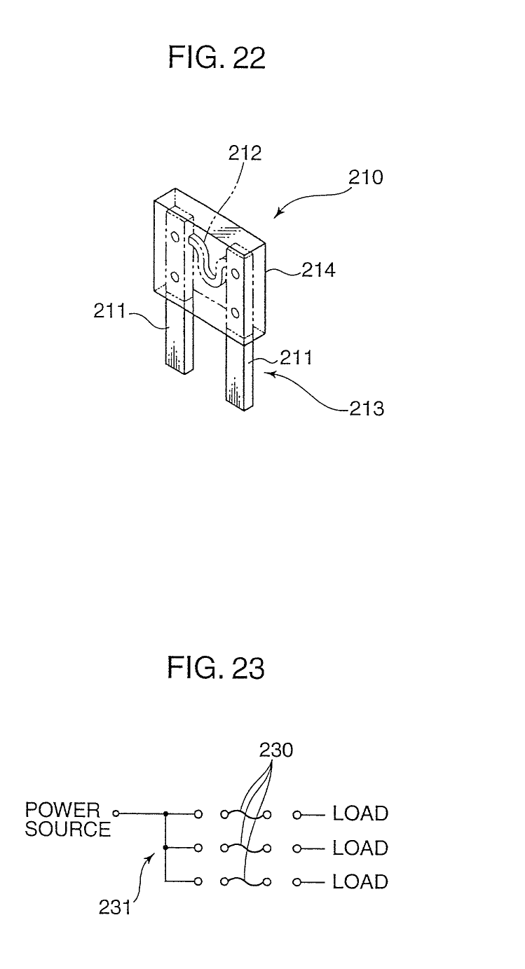

Although the fuse having the slit-shaped first notches 106a to 106dto form the connecting portions 103a, 103b, 104a, 104b as shown in FIGS. 10 and 11 are used as the fuse 101 of the fifth embodiment, the present invention is not limited to such a fuse. For example, a fuse 101C in which transversely outer bottom portions of the connection terminals 103, 104 are exposed, i.e., corner portions 106j, 106k at the opposite bottom ends of the insulating member 106 as shown in FIG. 18 may be used. Even in such a case, the same effects as the fifth embodiment can be obtained. Further, even if a fuse having no first notch, e.g., the fuse 210 as shown in FIG. 20, is used, the connection terminals 211 of the adjacent fuses 210 can be shorted by providing the second notches in the insulating member 212.

Although the shorting member having two comb-shaped press-contact blades are used in the fifth embodiment, the shorting member used in the present invention is not limited thereto. For example, a shorting member having three or more comb-shaped press-contact blades may be used or shorting members having different numbers of comb-shaped press-contact blades may be used in combination. In such a case, the fusing portions corresponding to the number of the comb-shaped press-contact blades can be connected in parallel.

Further, although the second notches 106e to 106h are formed to be long along the spaced-apart direction of two terminals 103, 104 in the fifth embodiment, the present invention is not limited to such second notches. For example, they may be formed to be long in a direction oblique to the spaced-apart direction of the two terminals 103, 104.

Furthermore, although the second notches are formed not only at the side of the input terminal 104, but also at the side of the output terminal 103 in the fifth embodiment, they may be formed only at the side of the input terminal 104 according to the present invention. However, if the second notches are formed at the sides corresponding to both terminals, these terminals can be used both as an input terminal and as an output terminal. Thus, it is not necessary to consider the orientation of the fuse when the fuse is mounted into connection with the busbar, thereby improving an assembling operability. In the case that the second notches are provided only for the input terminal as described above, a projection or a recess used to pull the fuse is preferably provided at the side of the output terminal 103 in order to enable the fuse to be pulled by a fuse pulling device.

As described above, an inventive fuse is provided with a fusing portion; connection terminals provided at the opposite ends of the fusing portion and electrically connectable with connecting members each having a forked inserting portion engageable with the connection terminal; and an insulating covering member for covering the fusing portion and a part of the connection terminals, the insulating covering member being formed with first notches for receiving leading ends of the connecting members and exposing another part of the connection terminals.

Since the inventive fuse is constructed such that the insulating covering member is present at the lateral sides of the first notches formed in the covering member and the leading ends of the connecting members are insertable into the first notches, high insulation can be ensured by suppressing the exposing degree of the sections of the connection terminals, and the height of the fuse in its mounted state can be shortened. Therefore, an electrical connection box using the inventive fuse can be made substantially smaller.

Preferably, the first notches may be in the form of a slit extending in an inserting direction of the connection terminals into the forked inserting portions.

Since the slit-shaped first notches extend in the inserting direction of the connection terminals into the forked inserting portions in this fuse, high insulation can be ensured by suppressing an exposing degree of the sections of the connection terminals and the height of the fuse in its mounted state can be shortened while maintaining a specified engaging length between the connection terminals and the forked inserting portions.

Preferably, the two connection terminals may be entirely covered by the covering member excluding sections thereof exposed through the first notches.

Since the two connection terminals are entirely covered by the covering members except their sections corresponding to the first notches, i.e., the connection terminals are located in the covering member in this fuse, the height of the fuse can be shortened to the height of the covering member and an exposed area can be suppressed to a minimum level.

Also, an inventive fuse mounting structure comprises the inventive fuse, and connecting members each having a forked inserting portion formed at one end. The connection terminals of the fuse are insertable into the forked inserting portions, and one end of each connecting member is insertable into the corresponding first notch.

Since the insulating covering member is present at the lateral sides of the first notches formed in the covering member and the leading ends of the connecting members are insertable into the first notches in this fuse mounting structure, high insulation can be ensured by suppressing the exposing degree of the sections of the connection terminals, and the height of the fuse in its mounted state can be shortened. Therefore, an electrical connection box using the inventive fuse can be made substantially smaller.

Preferably, there may be further provided a connection casing having a built-in circuit. The other end of each connecting member is electrically connected with the circuit, and the forked inserting portion at the one end of each connection terminal is exposed from the connection casing.

Since the circuit built in the connection casing is connected with the fuse via the connection terminals, a damage of the circuit caused by an over current can be prevented.

Preferably, the first notches of the fuse may be slits having a width substantially equal to the thickness of the connecting members.

Since the width of the first notches is substantially equal to the thickness of the connecting members in this fuse mounting structure, an exposed area of the connection terminals in the fuse can be reduced. Further, the first notches function as a guide for guiding insertion of the connecting members.

Preferably, a recess may be formed in a portion of the connection casing surrounding the forked inserting portions, and part of the fuse is accommodated in the recess. In such a case, part of the fuse accommodated in the recess may be the connection terminals of the fuse or the covering member of the fuse.

In this fuse mounting structure, not only the height of the fuse itself can be shortened, but also that of the fuse in its mounted state can be shortened since part of the fuse is located in the recess formed in the connection casing.

Preferably, the leading ends of the forked inserting portions may project out from an opening of the recess.

Since the connection terminals can be inserted with the leading ends of the projecting forked inserting portions as a guide in this fuse mounting structure, the fuse can be easily positioned.

Preferably, a stepped portion used to pull the fuse out may be provided at each of the opposite sides of a portion of the covering member exposed to outside from the connection casing.

In this fuse mounting structure, the fuse can be easily pulled out using, for example, a puller (fuse pulling device) by taking advantage of the stepped portions.

Preferably, a partition wall for partitioning the recess into inner and outer sections may be provided at a position deeper than the fuse in the recess of the connection casing in which the fuse is mounted. The partition wall may be formed with insertion holes through which the connecting members are inserted to prevent the connection members from shaking.

Since the connecting members are so provided as not to shake in this fuse mounting structure, the fuse can be more easily mounted.

Preferably, a rib for holding the covering member of the fuse connected with the connecting members may project around the opening of the recess of the connection casing.

Since the rib holds the covering member after the fuse is mounted in the connection casing in this fuse mounting structure, a mounted state of the fuse can be maintained even upon being subjected to an external force.

Further, an inventive fuse is provided with an input terminal; an output terminal; a fusing portion provided between the input terminal and the output terminal; an insulating covering member for covering the fusing portion and a part of the two terminals, the insulating covering member being formed with notches for receiving a shorting member, the input terminal being exposed through the notches.

In this fuse, the input terminals are connected in parallel upon being shorted by the shorting member, and it is sufficient to connect one of these input terminals with the input-side busbar connected with the common power source. Thus, the number of the input-side busbars can be reduced, with the result that an electrical connection box can be made substantially smaller. Further, the busbars used can have a simple shape having a small number of connecting portions with the fuse, and a design change can be easily dealt with by shorting the fuses.

Specifically, the conventional fuse is not so constructed that connection terminals thereof are independent and connectable with each other, and two connection terminals (input terminal and output terminal) are respectively connected with tab terminals of busbars. Thus, as shown in FIG. 23, the complicatedly shaped input-side busbars 231 for connecting the common power source and the input terminals of the respective fuses 230 have to be incorporated into the busbar circuit. Such busbars 231 cannot be easily handled, and a busbar circuit using differently shaped busbars 231 needs to be newly built even if the fuse circuit is to be slightly changed (e.g., the number of branching is changed). Therefore, a design change cannot be easily made.

Moreover an inventive fuse circuit comprises a plurality of the inventive fuses, and busbars connected with the respective terminals of the plurality of fuses. The input terminals connected with a common power source are shorted by a shorting member without the busbars, and one of these input terminals is connected with the busbar.

In this fuse circuit, the input terminals connected with the common power source are connected in parallel upon being shorted by the shorting member, and it is sufficient to connect one of these input terminals with the input-side busbar. Thus, the number of the input-side busbars can be reduced, with the result that an electrical connection box can be made substantially smaller. Further, the busbars used can have a simple shape having a small number of connecting portions with the fuse, and a design change can be easily dealt with by shorting the fuses.

Preferably, the second notches may be so formed in the opposite surfaces of the insulating covering member as to reach a side surface of the insulating covering member located between the opposite surfaces, and the shorting member includes a comb-shaped press-contact blade for holding the section of the input terminal exposed through the second notches.

In this fuse circuit, the fusing portions can be easily connected in parallel only by inserting the shorting member into the second notches.

Preferably, the fuses may be arrayed at specified intervals in row direction substantially normal to a direction in which the two terminals are spaced apart, and the shorting member includes a plurality of comb-shaped press-contact blades arrayed at the same intervals.

In this fuse circuit, the shorting member can be mounted into connection with arbitrary ones of the plurality of arrayed fuses, and it does not matter where the shorting member is mounted.

Preferably, there may be further provided an insulating protection cover for surrounding the fuses and the shorting member mounted to hold the input terminals of the fuses.

In this fuse circuit, the protection cover can prevent an external force from acting on the fuses and the shorting member and protect an insulated state of the fuses and the shorting member from outside.

Preferably, the protection cover may be provided for each row of the arrayed fuses.

In this fuse circuit, the protection cover can prevent a short circuit between the fuses in adjacent rows, a short circuit between the shorting members in adjacent rows and a short circuit between the fuse and the shorting member.

This application is based on patent application Nos. 2000-355230 and 2000-388343 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A fuse comprising:
a fusing portion;
connection terminals provided at the opposite ends of the fusing portion and electrically connectable with connecting members each having a forked inserting portion engageable with the connection terminal; and
an insulating covering member for covering the fusing portion and a part of the connection terminals, the insulating covering member being formed with notches for receiving leading ends of the connecting members and exposing another part of the connection terminals.

2. A fuse according to claim 1, wherein the notches are in the form of a slit extending in an inserting direction of the connection terminals into the forked inserting portions.

3. A fuse according to claim 2, wherein the connection terminals are entirely covered by the insulating covering member excluding the another part thereof.

4. A fuse mounting structure, comprising:
connecting members each having a forked inserting portion formed at one end,
a fuse including:
a fusing portion;
connection terminals provided at the opposite ends of the fusing portion and electrically connectable with the connecting members, the forked inserting portions being engageable with the connection terminals; and
an insulating covering member for covering the fusing portion and a part of the connection terminals, the insulating covering member being formed with notches for receiving leading ends of the connecting members and exposing another part of the connection terminals.

5. A fuse mounting structure according to claim 4, further comprising a connection casing having a built-in circuit, wherein the other end of each connecting member is electrically connected with the circuit, and the forked inserting portion at the one end of each connection terminal is exposed from the connection casing.

6. A fuse mounting structure according to claim 4, wherein the notches of the fuse are slits having a width substantially equal to the thickness of the connecting members.

7. A fuse mounting structure according to claim 6, wherein a recess is formed in a portion of the connection casing surrounding the forked inserting portions, and part of the fuse is accommodated in the recess.

8. A fuse mounting structure according to claim 7, wherein part of the fuse accommodated in the recess is the connection terminals of the fuse.

9. A fuse mounting structure according to claim 7, wherein part of the fuse accommodated in the recess is the covering member of the fuse.

10. A fuse mounting structure according to claim 9, wherein the leading ends of the forked inserting portions project out from an opening of the recess.

11. A fuse mounting structure according to claim 10, wherein a stepped portion used to pull the fuse out is provided at each of the opposite sides of a portion of the covering member exposed to outside from the connection casing.

12. A fuse mounting structure according to claim 11, wherein a partition wall for partitioning the recess into inner and outer sections is provided at a position deeper than the fuse in the recess of the connection casing in which the fuse is mounted, and the partition wall is formed with insertion holes through which the connecting members are inserted to prevent the connection members from shaking.

13. A fuse mounting structure according to claim 12, wherein a rib for holding the covering member of the fuse connected with the connecting members projects around the opening of the recess of the connection casing.

14. A fuse comprising:
an input terminal;
an output terminal;
a fusing portion provided between the input terminal and the output terminal;
an insulating covering member for covering the fusing portion and a part of the two terminals, the insulating covering member being formed with notches for receiving a shorting member, the input terminal being exposed through the notches.

15. A fuse circuit, comprising:
a plurality of fuses, each fuse including:
an input terminal;
an output terminal;
a fusing portion provided between the input terminal and the output terminal;
an insulating covering member for covering the fusing portion and a part of the two terminals, the insulating covering member being formed with notches for receiving a shorting member, the input terminal being exposed through the notches;
busbars for connecting terminals of the plurality of fuses;
wherein the input terminals are connected with a common power source, and are shorted by a shorting member, and one of the input terminals is connected with a busbar.

16. A fuse circuit according to claim 15, wherein the notches are so formed in the opposite surfaces of the insulating covering member as to reach a side surface of the insulating covering member located between the opposite surfaces, and the shorting member includes a comb-shaped press-contact blade for holding the section of the input terminal exposed through the notches.

17. A fuse circuit according to claim 16, wherein the fuses are arrayed at specified intervals in row direction substantially normal to a direction in which the two terminals are spaced apart, and the shorting member includes a plurality of comb-shaped press-contact blades arrayed at the same intervals.

18. A fuse circuit according to claim 17, further comprising an insulating protection cover for surrounding the fuses and the shorting member mounted to hold the input terminals of the fuses.

19. A fuse circuit according to claim 18, wherein the protection cover is provided for each row of the arrayed fuses.
